(19) United States
(12) Patent Application Publication
(10) Pub. No.: US 2007/0097986 A1
(43) Pub. Date: May 3, 2007

(54) Peer-to-peer communication architecture and terminals

(76) Inventors: Hosame H. Abu-Amara, Round Lake, IL (US); Yogesh B. Bhatt, Schaumburg, IL (US); Sanjay Gupta, Lakewood, IL (US); Joon Young Park, Libertyville, IL (US)

Correspondence Address: MOTOROLA INC, 600 NORTH US HIGHWAY 45, ROOM AS437, LIBERTYVILLE, IL, 60048-5343, US

(21) Appl. No.: 11/265,447

(22) Filed: Nov. 2, 2005

(51) Int. Cl. H04L 12/56

(52) U.S. Cl. 370/395.31

(57) ABSTRACT

A peer communication terminal 200 programmed to operate in a peer-to-peer network. The terminals includes a transceiver 210, a controller 220 coupled to the transceiver and to a memory device 230, and a a mapping table stored in memory, wherein the mapping table associates a terminal identity to corresponding transport information for at least one other peer terminal.

### FIELD OF THE DISCLOSURE

The present disclosure relates generally to peer-to-peer communications, networks, mobile terminals and methods, and more particularly to managing peer identification (ID) information where each peer has a dynamically changing transport ID, for example, an IP address and/or a TCP port on peer communication terminals.

### BACKGROUND

Peer-to-peer communication generally refers to collaboration by message transfers among terminals capable of data transmission over wireless and/or wire-line communication networks. Such terminals are generally referred to as peers, and groups of peers are referred to as peer-to-peer networks. Essentially, a peer-to-peer network is a network of peers, by peers, for peers.

Peer terminals generally have one or more unique identifiers and a transport identity. If an Internet Protocol (IP) network is used, for example, the transport identity is an IP address and/or a TCP port. The transport identity generally changes depending on the location of the peer. In client-server architectures, the peer identifiers and transport identities are conventionally stored on a name server, which may be accessed by terminals in the peer network. Servers however are costly and require maintenance.

The Internet Engineering Task Force (IETF) Domain Name Service (DNS) is a distributed database used in Internet Protocol (IP) network applications to map hostnames and IP addresses, wherein the databases reside on dedicated name servers. The IP addresses of these name servers are known and static. Updating IP addresses on the name servers is a tedious and cumbersome process requiring a specific protocol. Updates also require time to propagate throughout the network, during which time the information at various parts of the network is inconsistent. In DNS servers, compliance with strict hostname format rules is required. Also, the DNS name space is hierarchical, and names in parts of the hierarchy must be purchased and registered in advance with the Internet Corporation for Assigned Names and Numbers (ICANN).

Muthitacharoen et al., “Serving DNS using a Peer-to-Peer Lookup Service”, MIT Laboratory for Computer Science, disclose in using peer-to-peer architectures to store and locate DNS records. This system however shares the shortcomings of DNS-based solutions and requires that DNS records contained in a peer be migrated to other peers when the peer fails or departs from the network. In these architectures a mechanism is required to detect when peers no longer exist and to transfer information they contain to other peers.

The various aspects, features and advantages of the disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates a peer-to-peer communication architecture.

FIG. 2 illustrates a peer terminal architecture.

FIG. 3 illustrates a peer terminal information matting table.

FIG. 4 is a process diagram.

### DETAILED DESCRIPTION

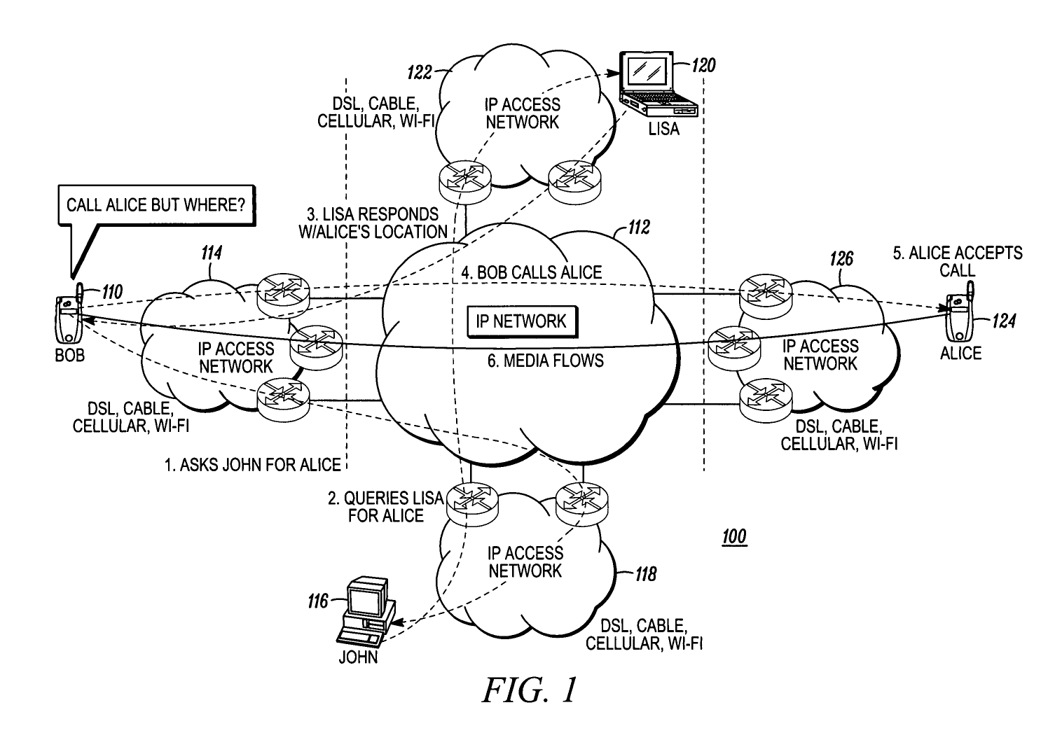

In the peer-to-peer communication architecture 100 of FIG. 1, two or more peer terminals communicate with one another over a communication network. The network generally comprises wireless and/or wire-line networks. Exemplary networks include Digital Subscriber Line (DSL), cable, Wifi and cellular communication networks among others. Terminals are generally referred as peer terminals or peers. A group of peer terminals is generally referred as a peer-to-peer network.

In FIG. 1, a cellular peer terminal 110 is communicably coupled to an Internet Protocol (IP) network 112 by access network 114, a fixed base peer terminal 116 is communicably coupled to the IP network 112 by access network 118, a mobile laptop peer terminal 120 is communicably coupled to the IP network 112 by access network 122, and cellular peer terminal 124 is communicably coupled to the IP network via access network 126. Other peer terminals may take other forms, and thus the disclosure is not limited to any particular terminal form.

In one embodiment, peer terminals in the peer-to-peer network collaborate via message transfers among terminals capable of data transmission in order to collectively render functionalities conventionally provided by dedicated computing nodes in the networks also known as servers, switches and databases. One such network entity or function that may be eliminated is that associated with the storage and management of terminal identity and corresponding terminal transport information. In one embodiment, all terminals in the peer-to-peer network are equivalent with regards to contribution and sharing of their resources in the network as discussed further below.

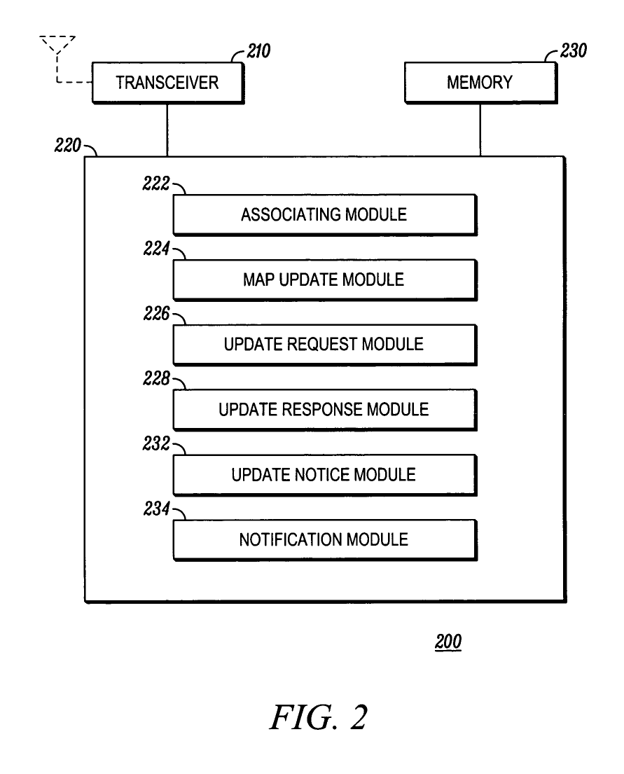

In FIG. 2, an exemplary peer terminal 200 generally comprises a transceiver 210 for communicating with other peer terminals. The transceiver may include a wireless and/or wire-line modem depending on the terminal type or configuration. The transceiver is generally compliant with any one or more of a number of different open or proprietary communication protocols. The transceiver 210 is communicably coupled to a controller 220, which is communicably coupled to memory 230. The terminal also includes a user interface and other elements and features known generally to those having ordinary skill in the art. In one embodiment, the controller is a programmable device controlled by software residing in memory. In one embodiment, features and functions of the controller are controlled by software controlled modules, non-limiting examples of which are discussed further below. The disclosed modules may be implemented equivalently as relatively dedicated hardware features or circuits.

Each peer terminal includes at least one unique terminal identity and at least one transport identity. Each terminal may also include multiple identities, for example, multiple user names. Generally, at least some of the peer terminals and in one embodiment all terminals that communicate in the peer-to-peer network include a mapping table, stored in memory, with information for or about one or more other peer terminals. The mapping table generally includes information entries for a limited number of peer terminals, as discussed further below. In one embodiment, each entry stored in the mapping table includes the terminal identity and the associated transport information, for example, the transport identity, for the corresponding peer terminal. The mapping table also includes one or more terminal identities and a corresponding transport identity for the terminal in which the mapping table resides. An illustrative transport identity is an Internet Protocol (IP) address, though more generally the transport identity may be an identity associated with any other type of network or protocol. More generally some other information or attribute associated with the peer terminal may change and require updating in the mapping table.

In FIG. 2, the terminal controller 220 includes an associating module 222 for performing the associating functions discussed above and below. The associating includes storing such information in the mapping table. The terminal identity and transport information may be obtained from other terminals when the other terminals join the peer-to-peer network, as discussed above.

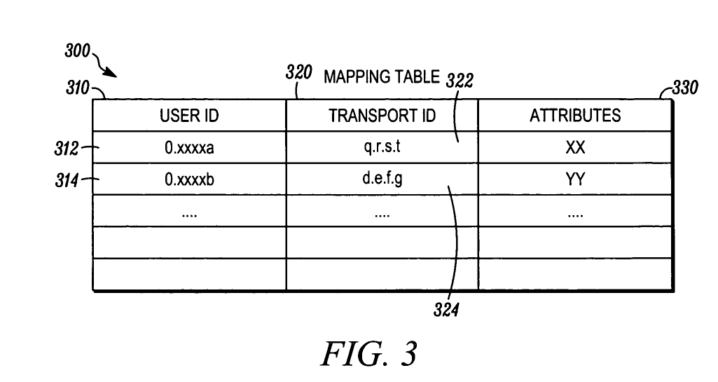

FIG. 3 is a logical mapping table 300 containing entries for multiple peer terminals. Table 300 associates at least one user identity 310 with a corresponding transport identity 320. For example, peer terminal user identity 312 is associated with transport identity 322, and peer terminal with user identity 314 is associated with transport identity 324. In some embodiments, multiple users, for example, multiple user identities or aliases, are associated with a single transport identity. The mapping table may also include one or more other attributes 330 associated with each peer terminal, examples of which are discussed further below. As noted, the associations may be managed including stored, updated and deleted by one or more associated modules in the controller.

In one embodiment, the table includes transport privacy information for the peer terminal. The transport privacy information indicates whether or not the transport information, and possibly other information, associated with a corresponding terminal has a privacy limitation, for example, a limitation on whether it may be distributed to to other peer terminals. In another embodiment, the mapping table includes available bandwidth connection size information for the corresponding or associated terminal. In other embodiments, the mapping table includes peer inquiry response time information for the associated peer terminal. The peer inquiry response time is indicative of how quickly the peer terminal responds to inquiries for information on other peer terminals, as discussed further below. The attributes discussed above are only exemplary. Generally each user may be associated with one or more of these and other attributes. In one embodiment, as suggested above, each terminal is minimally associated with a terminal identity and corresponding transport information.

In some peer-to-peer network environments, the transport identity for a particular peer terminal changes. For example, in embodiments where the peer terminal is a mobile wireless communication device, the transport identity may change as a consequence of changing their point of attachment in a network. In these and other embodiments where peer terminals change their network transport identity, or other attribute, a peer terminal updates the transport identities, or other attribute, of peer terminals in its mapping table when the transport information for the peer terminals changes. Such a change is usually indicated by a message from the terminals whose transport identity changes. The update notification may be in response to a query from the terminal or it may be in response to an unsolicited notification, as discussed further below. Peers terminals may thus update transport identity, or other information, for other peers upon receiving a notification or indication that the transport identity or other information has changed. In some embodiments, the terminal receiving the updated peer terminal information may not have a prior entry in its mapping table for the peer for which updated information has been received. In some embodiments, the receiving terminal may add the information for the peer sending the information to its mapping table. Each terminal also updates the mapping table entry for its own transport information or other updated information. Peer terminals this update their mapping tables dynamically. In FIG. 2, the terminal includes a transport identity updating module 224 for updating the peer transport identity and other attribute information for terminal entries stored in the mapping table. More generally, other information associated with terminal data entries in a mapping table may also be updated.

In one embodiment, a terminal obtains updated peer transport identity information by requesting it from one or more other peer terminals. More generally, the terminal may also update other information associated with the users in its mapping table. In FIG. 2, the terminal 200 includes an update request module 226 for requesting updated transport identity and/or other information for terminals in its mapping table. The request for updated information may be prompted by a returned message or expiration information associated with the particular terminal for which updated information is sought. For example, the peer terminal may request an updated transport identity if the transport identity has not been updated for a specified time period. The particular mechanism prompting the update however need not be limited to those discussed herein.

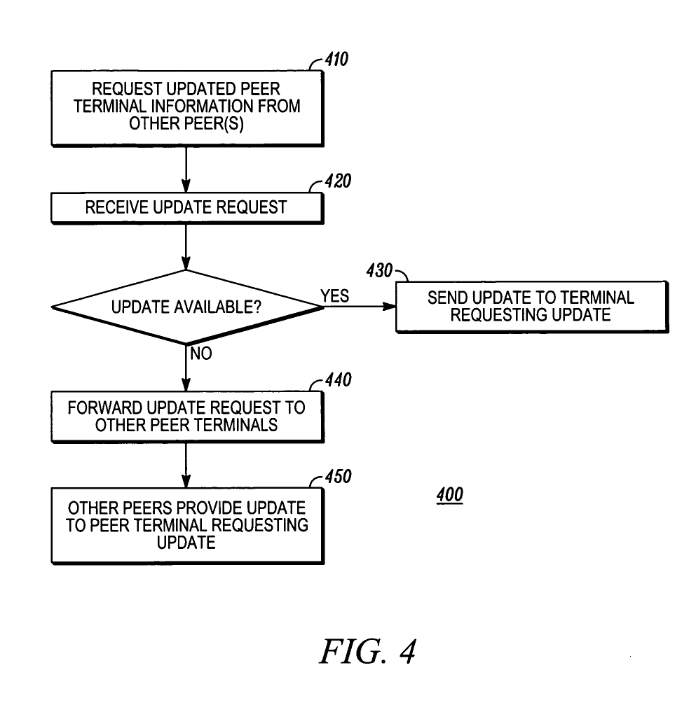

In the process diagram 400 of FIG. 4, at 410, a peer terminal queries one or more peer terminals for updated transport information for at least one other peer terminal. Alternatively, and more conventionally, the updated information may be obtained from a server or some other network infrastructure entity. In peer-to-peer networks, the terminal requesting the updated information obtains the updates from other peer terminals in the peer-to-peer network. In embodiments where the updated information is requested from a peer entity, for example, from one of the peer terminals in FIG. 1, the need for dedicated network servers providing this information is eliminated.

In peer-to-peer network embodiments, each peer maintains a mapping table providing the binding of peer identities to transport identities, as discussed above. Generally, the mapping table size or available resources within a terminal is finite. Thus in some embodiments, some logic for enabling a terminal to select which mappings to include in the table and which mappings to leave out of the table is desirable. Also, in one embodiment, the terminals for which mapping information is stored are prioritized. The selection and prioritization may be based on certain attributes or characteristics of the peer terminals stored in the mapping table or received from the peer terminals. Illustrative characteristics include, but are not limited to, whether the peer has a public transport identity, the size of the available connection bandwidth, historical response time information, how long the peer has been on the network (no shutdowns or network interrupts). For example, fixed based terminals are more likely to be permanently connected to the network than mobile terminals. Peers having some or all of these characteristics are likely more capable of reliably providing updated peer information in response to queries for updates. Thus by including the transport identities of peers having desirable characteristics in its mapping table, the terminal's search for updated transport identity and attribute information will be quicker and more efficient. The selection and prioritization of mapping table entries may be performed by the associating module 222 in FIG. 2.

Another mechanism that may be used to reduce the mapping table size is to delete entries for other peer terminals, for example, terminal identities and corresponding transport information. In one embodiment, mapping table entries are deleted if the transport or other information is not updated within a specified time period. Here, the assumption is that the transport identity or other information is likely to be invalid if it has not been updated within a specified time period. A time-out mechanism may also be used to indicate when to verify or when to update information in the mapping table rather than to delete it. Mapping table entries may also be deleted based on low prioritization, since a limited amount of memory is usually allocated to table entries. The addition and deletion of mapping table entries may also be performed by the associating module 222 in FIG. 2.

In peer-to-peer networks, a peer terminal seeking or requiring updated transport or other terminal attribute information sends the request to one or more of the peer terminals in its mapping table. In some embodiments, it may be desirable to limit the number of terminals to which inquiries are sent to reduce network traffic. The number of terminals queried may depend on the how urgently the updated information is required. Generally, the one or more terminals queried may be selected based on one or more of the attributes discussed above. For example, if response time is paramount, the query may be sent to one or more terminals having the quickest response time. The requesting of update information is performed by the update request module 226 in FIG. 2.

In some embodiments, terminals in the peer-to-peer network provide updated transport identity and/or attribute and/or other information in response to requests from other peer terminals. The information provided is generally located in the mapping table of the terminal to which the request was sent. Alternatively, this information is obtained from another terminal or entity in the peer-to-peer network. For example, if the initial recipient of the request does not have the update information requested, the request could be forwarded to other peer terminals, which directly or indirectly provide the information to the requesting terminal. In FIG. 2, the controller 220 of terminal 200 includes an update response module 228 for providing updated transport identity and/or attribute information to other peer terminals requesting this information.

In FIG. 4, at 420, one or more terminals receive a request for updated transport or other information. At 430, if the information is available at the terminal receiving the request, the peer terminal receiving the request provides the information requested to the requester terminal. At 440, if the information requested is not available at the peer terminal that received the request, the peer terminal receiving the request may forward the request to one or more other peer terminals in its mapping table. The update response module 228 in FIG. 2 controls the providing of updated transport identity and attribute information. This or another module may also forward the request for information to other peer terminals. In FIG. 4, at 450, another peer terminal provides the updated information to the requester in response to receiving forwarded request information.

Generally, peer terminal notify other peers in the peer-to-peer network when the notifying peer terminal joins the network. In one embodiment, the peer terminal provides its transport and other information one or more other peer terminals upon joining the peer-to-peer network. The one or more terminals to which this information is sent are identified in the mapping table of the terminal joining the network. The terminals in the network receiving this information may then update their mapping tables accordingly. Peer terminals may also notify other peers in the peer-to-peer network when the notifying peer terminal leaves the network. In some embodiments, when a peer is notified that another terminal is leaving the network, the notified terminal may delete the entry or information associated with the departing terminal from its mapping table. In FIG. 2, the terminal 200 includes a notification module 234 for notifying other peer terminals when it joins and leaves the peer-to-peer network.

In another embodiment, the mapping table in a peer is seeded with default mappings of terminal identifiers to transport information. When the peer joins the peer to peer network, the peer sends notifications of the join to the default terminals. The seeded information may be out-of-date, so the peer waits for acknowledgements from the default terminals. If the peer receives at least one acknowledgement, then the peer proceeds with normal operations. On the other hand, if the peer receives no acknowledgements, then the peer may initiate a query for the default terminal network information. The query may be sent to random peers or to a dedicated peer that is known a priori. The seeded information can be updated from time to time to ensure that peers have most up-to-date mapping information.

In FIG. 1, peer terminal 110 queries peer 116 for updated transport or other information about peer terminal 124. Peer 116 does not have the updated information requested and forwards the request to terminal 120. Terminal 120 forwards the requested information to terminal 110, thereby enabling terminal 110 to communicate with terminal 124.

In some embodiments, when the transport identity changes, the peer terminal provides its new transport information to the peer terminal in the mapping table. In FIG. 2, the controller 220 includes an update notice module 232 for notifying peer terminals in the mapping table of changes in the transport identity of the terminal sending the notification.

In one embodiment, when a peer joins the network or requests updated information, the requesting peer is authenticated by one or more other peer terminals. This process makes the peer a part of the peer-to-peer network, i.e., it can query other peers' transport identities and can be queried to by other peers. This process involves sending a transport identity associated with the peer to one or more peers. Other peer terminals in the network may thus update or add the newly connected terminal to their mapping tables.

In one embodiment, when a peer terminal disconnects from the network, its mapping remains intact. This allows the terminal to re-use the table upon re-joining the network, thereby reducing the number of queries sent to the default transport IDs. It is also possible for a terminal to inform peers with addresses in its mapping table) of an imminent departure. This allows these peers to purge the address of the departing terminal from their tables, thus saving valuable table space and avoiding unnecessary messaging to a terminal no longer connected to the network.

While the present disclosure and the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A peer communication terminal programmed to operate in a peer-to-peer network, the terminal comprising:
a transceiver;
a controller coupled to the transceiver, the controller coupled to a memory device;
a mapping table stored in memory, the mapping table associating a terminal identity to corresponding transport information for at least one other peer terminal.

2. The terminal of claim 1, the transport information contains at least transport identity information.

3. The terminal of claim 1, the mapping table also including in association with the at least one other peer terminal at least one of the following:
peer inquiry response time information indicative of how long the at least one other peer terminal requires to respond to inquiries for updated peer terminal information;
available bandwidth connection size information for the at least one other peer terminal;
update timer information for the at least one other peer terminal.

4. The terminal of claim 1, the controller for updating the transport information of the at least one other peer terminal when the peer communication terminal determines that the transport information of the at least one other peer terminal has changed.

5. The terminal of claim 1, the mapping table includes transport privacy information for the at least one other peer terminal, the transport privacy information indicating whether the corresponding transport information is private.

6. The terminal of claim 1 is a mobile wireless communication device.

7. The terminal of claim 1, the controller programmed to provide transport information to a third party peer terminal in response to a request from the third peer terminal.

8. The terminal of claim 1, the controller programmed to provide transport information to a third party peer terminal in response to a request from a second peer terminal.

9. The terminal of claim 1, the controller programmed to provide new transport information for the peer communication terminal to a third peer terminal when the transport information of the peer communication terminal changes.

10. The terminal of claim 1, the controller programmed to notify peers already part of a peer-to-peer network that the terminal has joined the network.

11. The terminal of claim 10, the controller programmed to choose selectively a limited number of peers in the peer-to-peer network to notify that the terminal has joined the network.

12. A method in a mobile peer communication terminal, the method comprising:
associating a terminal identity with corresponding transport information for at least one other peer terminal in a mapping table of the mobile peer communication terminal;
updating the transport information for the at least one other peer terminal when the peer communication terminal determines that the transport information of the other peer terminal has changed.

13. The method of claim 12, associating the terminal identity with corresponding transport privacy information for the at least one other peer terminal in the mapping table of the mobile peer communication terminal.

14. The method of claim 12, associating the terminal identity to a corresponding available bandwidth connection size information for the at least one other peer terminal in the mapping table of the mobile peer communication terminal.

15. The method of claim 12, associating the terminal identity to corresponding peer inquiry response time information for the at least one other peer terminal in the mapping table of the mobile peer communication terminal.

16. The method of claim 12, querying a third peer terminal for transport information for the at least one other peer terminal and receiving the said transport information.

17. The method of claim 12, sending the transport information for the at least one other peer terminal to a third peer terminal in response to receiving a request for the transport information from another peer terminal.

18. The method of claim 12, deleting the terminal identity and corresponding transport information for the at least one other peer terminal from mapping table if the transport information is not updated within a specified time period or because of low prioritization of the transport information.

19. A peer communication terminal capable of communicating in a peer to peer network of other peer terminals, the terminal comprising:
a transport information query module for requesting transport information for another peer terminal from another peer terminal;
a transport information receiving entity for receiving requested transport information;
a module for storing received transport information and terminal identities in a mapping table stored on the peer communication terminal.

20. The terminal of claim 19, a module for responding to requests for transport information received from other peer terminals, the response based on information stored in the mapping table.

21. The terminal of claim 19, a module for updating transport information of the peer terminal in the mapping table.

22. The terminal of claim 19, a module for looking up transport information corresponding to a terminal identity in the mapping table.

23. The terminal of claim 19, a module for joining a peer to peer network consisting of other peer terminals, each of the other peer terminals having:
a transport information query module for requesting transport information for another peer terminal from another peer terminal;
a transport information receiving entity for receiving requested transport information;
a module for inserting received transport information and terminal identities in a mapping table stored on the peer communication terminal.

24. The terminal of claim 23, each peer terminal having at least one unique terminal identity.

25. The terminal of claim 19, the mapping table associating a terminal identity to corresponding transport information for at least one other peer terminal.

26. The terminal of claim 19, a module for joining and leaving the peer network.
